(19) United States
(12) Patent Application Publication
(10) Pub. No.: US 2010/0134230 A1
(43) Pub. Date: Jun. 3, 2010

(54) TRANSFORMER WITH HIGH LEAKAGE INDUCTANCE

(76) Inventors: Chi-Chih WU, Taipei County (TW); Chun-Sian Wu, Taipei County (TW)

Correspondence Address: Muncy, Geissler, Olds & Lowe, PLLC, 4000 Legato Road, Suite 310, FAIRFAX, VA, 22033, US

(21) Appl. No.: 12/189,903

(22) Filed: Aug. 12, 2008

(51) Int. Cl. H01F 27/42

(52) U.S. Cl. 336/170

(57) ABSTRACT

The present invention provides a high leakage inductance transformer for solving the problem of insufficient leakage inductance in the conventional transformer. The transformer of the present invention includes a primary winding portion, two secondary winding portions mounted at two ends of the primary winding portion, and an iron core set having inner iron cores for penetrating the primary winding portion and the secondary winding portions and outer iron cores exposed out of the primary winding portion and the secondary winding portions and connected with the inner iron cores, so as to form a magnetic loop, wherein the primary winding portion has an intensifying winding portion for being penetrated by the outer iron cores, so as to increase the leakage inductance.

### FIELD OF THE INVENTION

The present invention is related to a transformer, and more particularly to a transformer with high leakage inductance.

### BACKGROUND OF THE INVENTION

Owing to the great development of LCD (Liquid Crystal Display), the standard of the lighting quality of the cathode ray tube in LCD also becomes higher. Since the demanded size of LCD becomes bigger and bigger, the quantity of cathode ray tubes used in the back light module within the LCD must be increased for improving the brightness, and thus, the high voltage transformer used for lighting the cathode ray tubes also should become more since the output quality and the additional functions of the high voltage transformer are critical for lighting the cathode ray tube. That is, according to the main stream of large screen and super thin for LCD, the volume of iron core of the transformer should be as small as possible and the quantity thereof also should be as fewer as possible. However, most importantly, the high voltage output quality and functions of the cathode ray tube should not be influenced by the volume or quantity reduced iron core in the transformer. Therefore, how to provide the high voltage required by the higher voltage cathode ray tube, how to reduce the volume of transformer iron core but still remain the function of one-input and multi-output, how to reduce the iron core amount in the transformer by sharing one common iron core with multiple transformers so as to reduce the volume, temperature and cost of LCD, and how to change the shape of iron core without changing the output quality and function of the transformer so as to conform to the demands of thinning and high leakage inductance for driving IC have already become significant for the current transformer.

Please refer to FIG. 1, which shows the leakage inductance of TWP No. M304106 is also disclosed by the present applicant. This patent disclosed a structure of bobbin for being wound by the primary wire and the secondary wire includes a shield 100 for the secondary bobbins which has two bobbin accommodating regions 102 for receiving two secondary winding regions, which are wound by the secondary wire, and a primary winding region 101 located between two bobbin accommodating regions 102 for being wound by the primary wire, and an iron core set 200 penetrates through the primary winding region 101 and the two secondary winding regions, so as to form a magnetic loop. Although the shield 100 for the secondary bobbins can isolate and protect the secondary wire and also increase the production speed and save assembling time and cost, the bobbin structure still can not produce sufficient leakage inductance at the secondary winding regions. As the testing frequency is 50 KHz/V, the interval of the iron core set 200 is 0.15 mm and the turn ratio of the primary winding region 101 to the secondary winding regions is 1:10, the secondary winding regions only can produce a leakage inductance of approximately 131 mH. Therefore, when the electronic components around the transformer need to be driven by a higher leakage inductance, this architecture obviously can not conform to this demand.

### SUMMARY OF THE INVENTION

The object of the present invention is to increase the leakage inductance produced by the secondary winding portions.

For achieving the object described above, the present invention provides a high leakage inductance transformer including a primary winding portion, two secondary winding portions mounted at two ends of the primary winding portion, and an iron core set having inner iron cores for penetrating the primary winding portion and the secondary winding portions and outer iron cores exposed out of the primary winding portion and the secondary winding portions and connected with the inner iron cores, so as to form a magnetic loop, wherein the primary winding portion has an intensifying winding portion for being penetrated by the outer iron cores, so as to increase the leakage inductance.

Accordingly, compared with the prior art the present invention is advantageous of capable effectively driving the electronic components surrounding the transformer with requirement of high leakage inductance.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the leakage inductance of the traditional transformer;

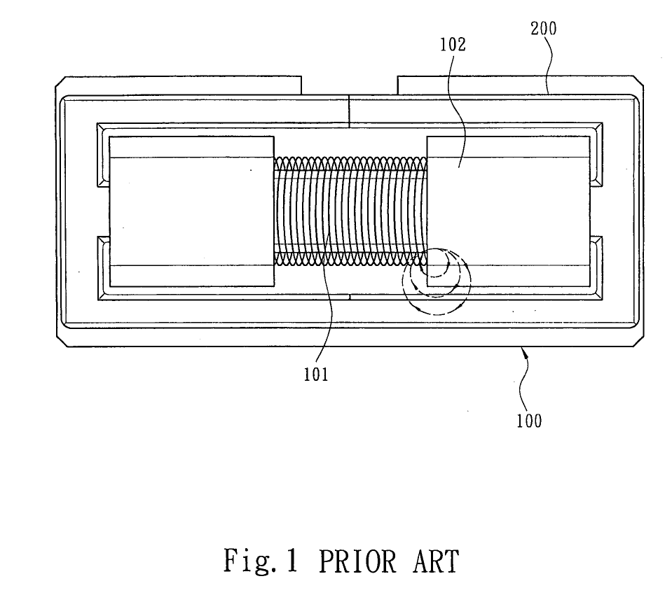

FIG. 2 is a schematic view showing the appearance of the present invention in a first embodiment;

FIG. 3 is a decomposition view showing the present invention in a first embodiment;

FIG. 4 is another decomposition view showing the present invention in a first embodiment;

FIG. 5 is a schematic view showing the leakage inductance of the present invention; and

FIG. 6 is a decomposition view showing the present invention in a second embodiment.

### DESCRIPTION OF THE PREFERRED EMBODIMENT

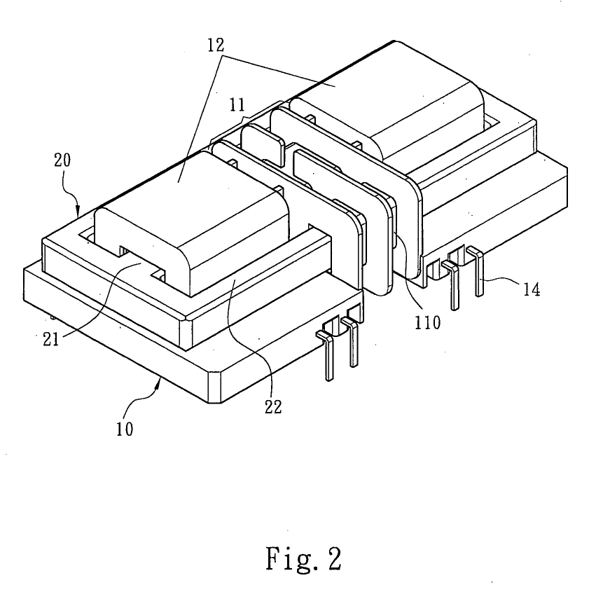

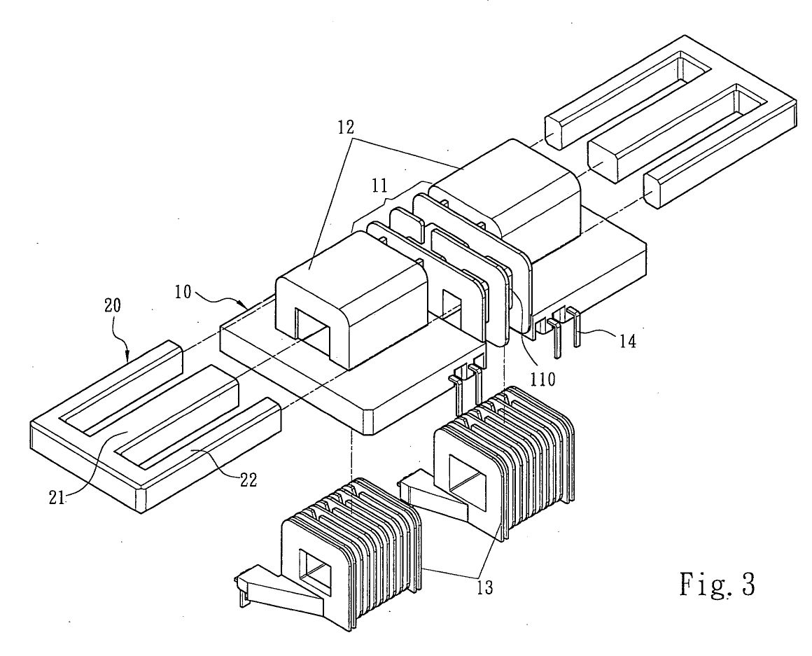

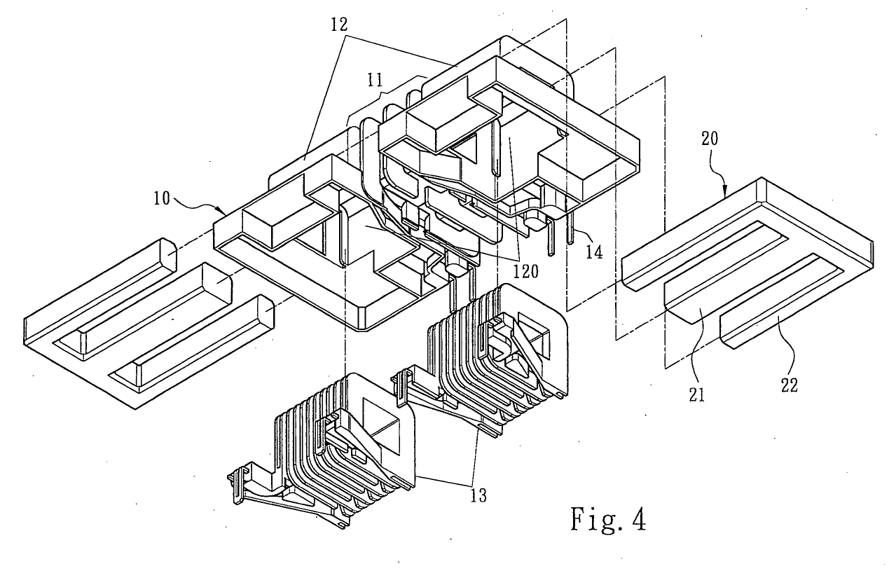

Please refer to FIG. 2, FIG. 3 and FIG. 4, which show the appearance and decompositions of the present invention in a first embodiment. The present invention provides a high leakage inductance transformer including a primary winding portion 11, two secondary winding portions 13 and an iron core set 20, wherein the secondary winding portions 13 are respectively mounted at the two ends of the primary winding portion 11, and the iron core set 20 includes inner iron cores 21 for penetrating the primary winding portion 11 and the secondary winding portions 13 and outer iron cores 22 connected with the inner iron cores 21 and exposed out of the primary winding portion 11 and the secondary winding portions 13, so as to form a magnetic loop. In the first embodiment, the primary winding portion 11 is mounted on a winding shelf cover 10, which has a plurality of pins 14 for connecting with primary wires (not shown) wound on the primary winding portion 11. The primary winding portion 11 has a cover portion 12 respectively at the two sides thereof, each cover portion 12 forming an accommodating space 120 therein for mounting the secondary winding portion 13, thereby increasing the creepage distance and thus preventing the surface discharge caused by electron puncture. Besides, it should be noticed that the primary winding portion 11 has an intensifying winding portion 110 for being penetrated the outer iron cores 22. Through the inner iron cores 21 and the outer iron cores 22 respectively penetrating the primary winding portion 11 and the intensifying winding portion 110, the leakage inductance of the present invention can be significantly increased for driving the electronic components (such as IC) around the transformer so as to conform to the industrial demands.

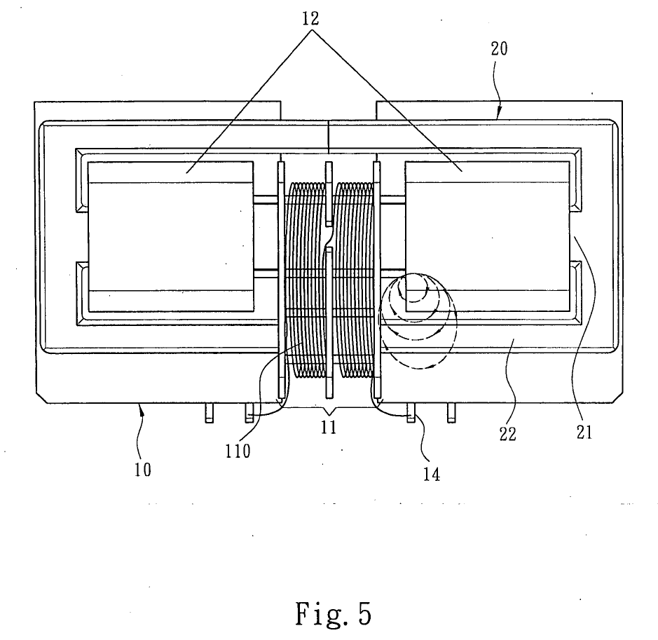

Besides, please refer to FIG. 5, which is a schematic view showing the leakage inductance of the present invention. In the present invention, when winding the primary wire, the primary wire needs to cross the primary winding portion 11 and the intensifying winding portion 110 and at the same time, also wind on them. When the primary wire is connected to electricity for generating magnetic field and inducing the secondary winding portions 13 to produce induced current, a large amount of leakage inductance will be produced at the secondary winding portions 13. As the testing frequency is 50 KHz/V, the interval of the iron core set 20 is 0.15 mm and the turn ratio of the primary winding portion 11 to the secondary winding portion 13 is 1:10, a leakage inductance of approximately 596 mH can be produced by the secondary winding portion 13, and in the traditional transformer without intensifying winding portion 110, under the same condition, only 131 mH leakage inductance can be provided. Therefore, it can be seen, the present invention increases the leakage inductance to conform to the demand that the electronic components around the transformer have to be driven by high leakage inductance.

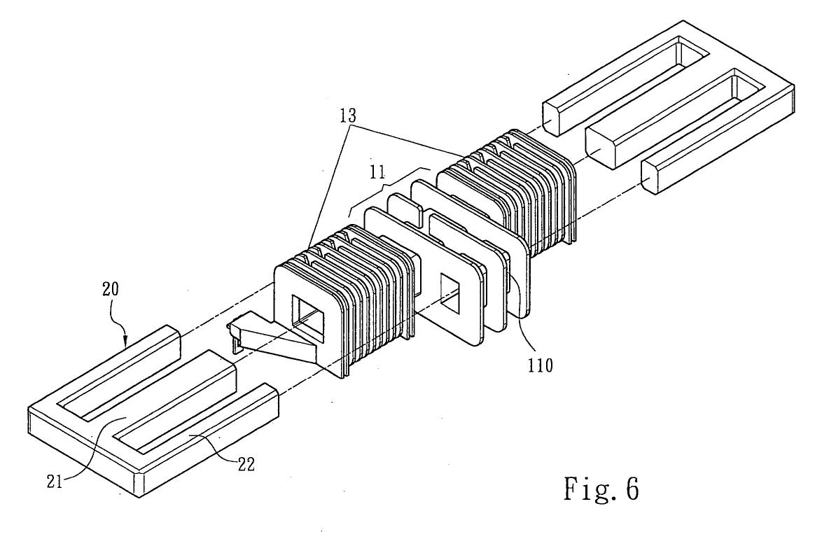

Moreover, except the EE type shown in figures, the iron core set 20 also can have other types, such as CF, CT, EC, EF, EI, EL, ET, FF, FL, UU or UI, and the primary winding portion 11 and the secondary winding portions 13 are not limited to be mounted on the winding shelf cover 10 and in the accommodating spaces 120 inside the cover portions 12. Furthermore, the primary winding portion 11 and the secondary winding portions 13 also can be formed integrally to be a single winding shelf, as shown in FIG. 6, with the secondary winding portions 13 located at the two ends of the primary winding portion 11. No matter the primary winding portion 11 is separated from the secondary winding portions 13 due to be mounted on the winding shelf cover 10 or the primary winding portion 11 and the secondary winding portions 13 are integrally formed together, the most important is through providing the intensifying winding portion 110 for penetrating the outer iron cores 22 of the iron core set 20, the present invention always can increase the leakage inductance produced by the secondary winding portions 13.

In the aforesaid, compared with the prior art, the present invention is advantageous of capable effectively driving the electronic components surrounding the transformer with requirement of high leakage inductance.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A high leakage inductance transformer, comprising:
a primary winding portion;
two secondary winding portions, mounted at two ends of the primary winding portion; and
an iron core set, having inner iron cores for penetrating the primary winding portion and the secondary winding portions and outer iron cores exposed out of the primary winding portion and the secondary winding portions and connected with the inner iron cores, so as to form a magnetic loop,
wherein the primary winding portion has an intensifying winding portion for being penetrated by the outer iron cores, so as to increase the leakage inductance.

2. The high leakage inductance transformer as claimed in claim 1, wherein the iron core set is a type selected from a group consisting of: EE, CF, CT, EC, EF, EI, EL, ET, FF, FL, UU and UI.

3. The high leakage inductance transformer as claimed in claim 1, wherein the primary winding portion is mounted on a winding shelf cover, and the winding shelf cover has a cover portion respectively mounted at two sides of the primary winding portion and each cover portion is formed to have an accommodating space for mounting the secondary winding portions.

4. The high leakage inductance transformer as claimed in claim 3, wherein the winding shelf cover has a plurality of pins for connecting with and being wound by a primary wire of the primary winding portion.

5. The high leakage inductance transformer as claimed in claim 3, wherein the iron core set is a type selected from a group consisting of: EE, CF, CT, EC, EF, EI, EL, ET, FF, FL, UU and UI.

6. The high leakage inductance transformer as claimed in claim 1, wherein the primary winding portion and the secondary winding portions are formed integrally for being mounted on one single winding shelf.
